(19) United States
(12) Patent Application Publication
(10) Pub. No.: US 2024/0273395 A1
(43) Pub. Date: Aug. 15, 2024

(54) AUTOMATED CUSTOMIZED MACHINE LEARNING MODEL VALIDATION FLOW

(71) Applicant: Kyndryl, Inc., New York, NY (US)

(72) Inventors: Divya Devaraj, Coimbatore (IN); Sanjana Sahayaraj, Chennai (IN); Aastha Rai, New York, NY (US); Omar Odibat, Cedar Park, TX (US)

(21) Appl. No.: 18/108,354

(22) Filed: Feb. 10, 2023

(51) Int. Cl. G06N 20/00

(52) U.S. Cl. CPC G06N 20/00

(57) ABSTRACT

In one aspect, a computer-implemented method includes detecting, by one or more processing devices, custom goals of a specified machine learning application; determining, by the one or more processing devices, relative importance of a plurality of performance categories for the specified machine learning application, based on the custom goals of the specified machine learning application; generating, by the one or more processing devices, automated machine learning model tests based on the determined relative importance of the plurality of performance categories for the specified machine learning application; and performing, by the one or more processing devices, validation testing of the machine learning model based on the automated machine learning model tests.

### BACKGROUND

Aspects of the present invention relate generally to machine learning and, more particularly, to validating machine learning models.

An essential element of machine learning training is selecting portions of a dataset for performing training of a machine learning model, and reserving portions of the same dataset for both testing and validating the machine learning model trained on the training data portion. Standardized training and validating modules, such as accuracy tests and benchmarking tests, are typically used to streamline the training and validating steps.

### SUMMARY

In a first aspect of the invention, there is a computer-implemented method including: detecting, by one or more processing devices, custom goals of a specified machine learning application; determining, by the one or more processing devices, relative importance of a plurality of performance categories for the specified machine learning application, based on the custom goals of the specified machine learning application; generating, by the one or more processing devices, automated machine learning model tests based on the determined relative importance of the plurality of performance categories for the specified machine learning application; and performing, by the one or more processing devices, validation testing of the machine learning model based on the automated machine learning model tests.

In another aspect of the invention, there is a computer program product including one or more computer readable storage media having program instructions collectively stored on the one or more computer readable storage media. The program instructions are executable to: detect custom goals of a specified machine learning application; determine relative importance of a plurality of performance categories for the specified machine learning application, based on the custom goals of the specified machine learning application; generate automated machine learning model tests based on the determined relative importance of the plurality of performance categories for the specified machine learning application; and perform validation testing of the machine learning model based on the automated machine learning model tests.

In another aspect of the invention, there is system including a processor, a computer readable memory, one or more computer readable storage media, and program instructions collectively stored on the one or more computer readable storage media. The program instructions are executable to: detect custom goals of a specified machine learning application; determine relative importance of a plurality of performance categories for the specified machine learning application, based on the custom goals of the specified machine learning application; generate automated machine learning model tests based on the determined relative importance of the plurality of performance categories for the specified machine learning application; and perform validation testing of the machine learning model based on the automated machine learning model tests.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment including a machine learning model validation customizer system, in accordance with aspects of the present invention.

FIG. 5 shows a flowchart of an exemplary method in accordance with aspects of the present invention.

FIG. 6 depicts a flowchart for a method for a model validation customizer system performing polarity analysis on the test requirements, in accordance with aspects of the present invention.

FIG. 7 depicts a bar chart for a set of normalized relative value scores of a set of quality pillar performance categories based on the custom goals of a specified machine learning application, as determined in a polarity analysis by a model validation customizer system, in accordance with aspects of the present invention.

FIG. 8 depicts a flowchart for an illustrative method that may be performed by a model validation customizer system, in accordance with aspects of the present invention.

### DETAILED DESCRIPTION

Aspects of the present invention relate generally to validating machine learning models and, more particularly, to automated validation of machine learning models in accordance with customized quality pillar performance categories (i.e., quality pillars). While machine learning enables broad capabilities, there is often a tremendous gap between known machine learning models and specific real-world application products and services in a production-ready form for use by intended end users. Known training and validating techniques (regardless of the application of the machine learning models) typically fail to reflect any particular needs or performance goals of a specific application of the machine learning model. Using such known techniques may also fail to align with the operating or business needs of the users of a machine learning model.

Instead, in various aspects of the present disclosure, a system, device, or method of this disclosure may automatically detect the customized relative importance of each of several quality pillar performance categories of a particular machine learning model, in the context of its particular application, and perform a customized dynamic training data generation, testing, and validation of the machine learning model to scale and flexibly focus on the quality pillars in accordance with their relative importance to the particular machine learning model in a specific application. Accordingly, implementations of this disclosure may automatically generate machine learning models and applications that operate in accordance with relevant performance goals. Thus, implementations of the disclosure provide novel and inventive advantages relative to known conventional systems.

Various aspects of the present disclosure may be directed to a method and system for customizing validation flow for a business use case or model under test by balancing quality pillar performance categories such as accuracy, runtime, memory consumption, security, robustness, explainability, monitoring capability, and so forth. More specifically, various aspects of this disclosure may be directed to designing template blocks for the quality pillars relating to code execution time, explainability, model metrics, and so forth. Various aspects of this disclosure may be directed to performing polarity analysis of documented requirements to identify conflicting interests in quality pillar performance categories, which are the basis for quality pillar template blocks. Various aspects of this disclosure may be directed to dynamically creating test and validation flow, including corner and edge case tests. Various aspects of this disclosure may be directed to generating multi-variety data for tests identified and presenting them in a user-friendly report to provide additional information to aid end users.

Various aspects of the present disclosure may be valuably implemented and yield novel and inventive benefits in a variety of domains, such as cloud computing, healthcare, and banking and finance, and any others that are susceptible to useful deployment of machine learning and artificial intelligence applications. For example, in cloud computing, examples of the present disclosure may be used to improve cloud management systems, anomaly detection, and cost forecasting. In healthcare, examples of the present disclosure may be used to improve medical imaging, drug development, and AI-powered medical advice. In banking and finance, examples of the present disclosure may be used to improve fraud detection and risk modeling.

Implementations of this disclosure are necessarily rooted in computer technology. For example, steps of generating automated machine learning model tests for a machine learning model, based on the determined relative importance of the plurality of performance categories for the specified machine learning application, and performing validation testing of the machine learning model based on the automated machine learning model tests, are necessarily computer-based and cannot be performed in the human mind. Further aspects of the present disclosure are beyond the capability of mental effort not only in scale and consistency but also technically and categorically, and may enable generating automated machine learning model tests for a machine learning model, based on the determined relative importance of the plurality of performance categories for the specified machine learning application, and performing validation testing of the machine learning model based on the automated machine learning model tests, with both optimization and speed across cloud applications of arbitrarily high scale and complexity in ways definitively beyond the capability of human minds unaided by computers. Further, aspects of this disclosure provide technological improvements and technological solutions to persistent, complex problems and challenges in conventional machine learning application validation testing and deployment. For example, aspects of this disclosure may ensure generating automated machine learning model tests for a machine learning model based on the determined relative importance of the plurality of performance categories for the specified machine learning application, and performing validation testing of the machine learning model based on the automated machine learning model tests, in cloud-deployed machine learning applications of arbitrarily high size and complexity and with arbitrarily large-scale global deployment and scalability, including achieving faster and more reliable performance, higher security, avoidance of downtime, and lower cost, in ways that may be categorically beyond the capabilities of known systems.

It should be understood that, to the extent implementations of the invention collect, store, or employ personal information provided by, or obtained from, individuals (for example, any personal information included in data sets used as training data and test and validation data), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

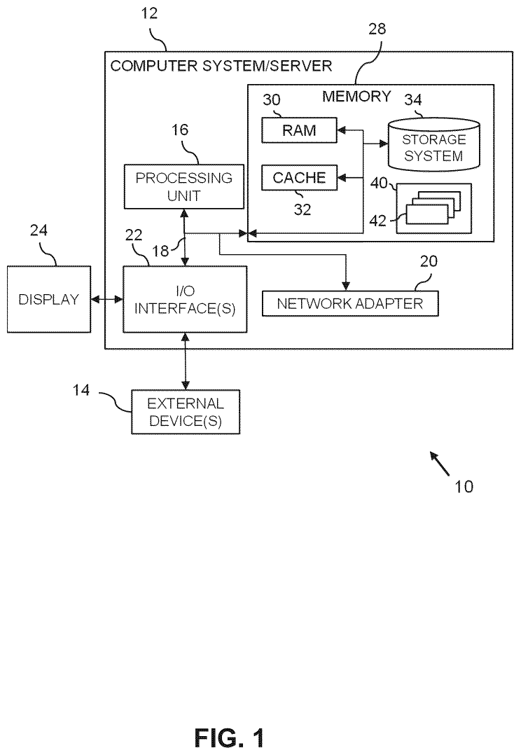

Referring now to FIG. 1, a schematic of an example of a cloud computing node 10 is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

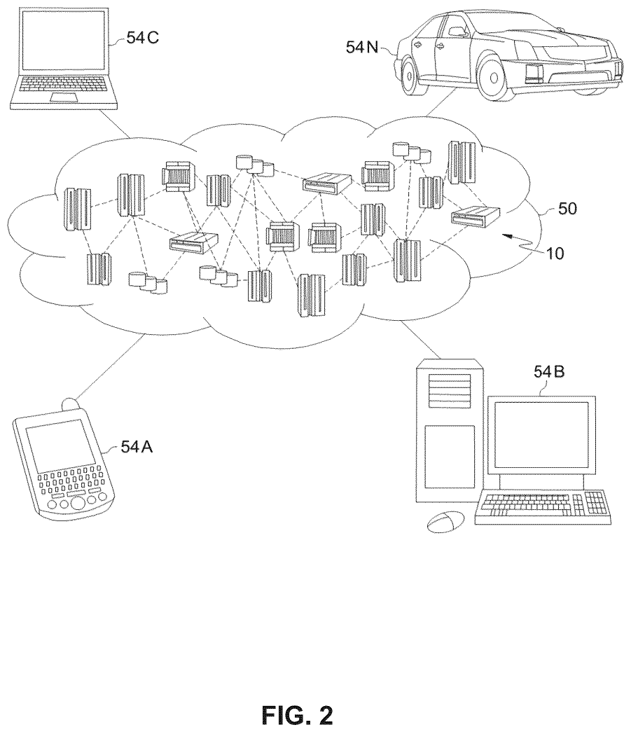

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

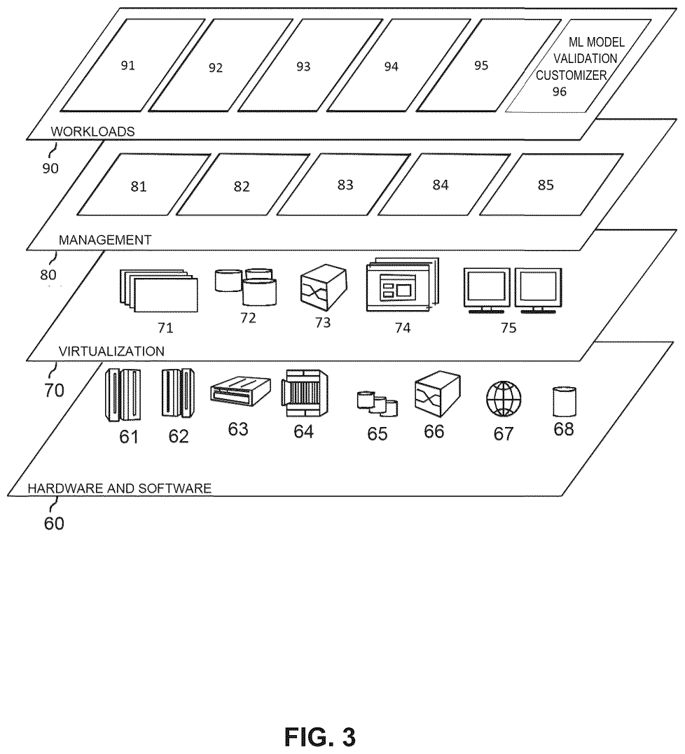

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and machine learning (ML) model validation customizer 96.

Implementations of the invention may include a computer system/server 12 of FIG. 1 in which one or more of the program modules 42 are configured to perform (or cause the computer system/server 12 to perform) one of more functions of the ML model validation customizer 96 of FIG. 3. For example, the one or more of the program modules 42 of the ML model validation customizer 96 may be configured to perform custom goal detection, quality pillar performance category importance determination, ML validation test generation, and ML validation test performance.

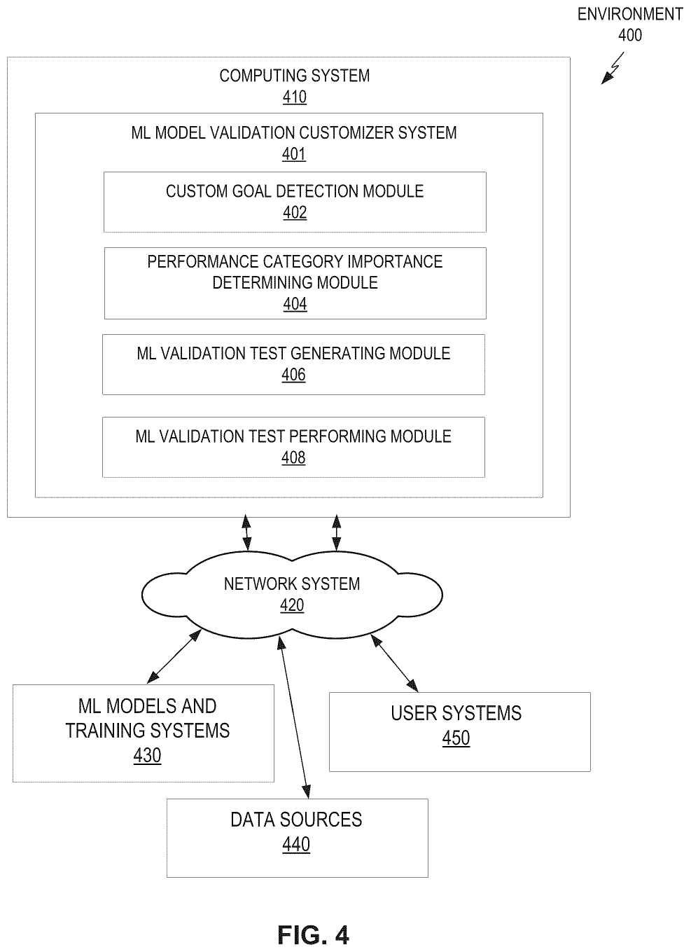

FIG. 4 shows a block diagram of an exemplary environment 400 including ML model validation customizer system 401, in accordance with aspects of the invention. In various embodiments, environment 400 includes computing system 410 hosting ML model validation customizer system 401, network system 420, ML models and training systems 430, data sources 440, and user systems 450. Users may interact with user systems 450 to design ML models and train ML models in ML models and training systems 430 using data sources 440, with data divided among training data and validation testing data. Users may then make use of ML model validation customizer system 401 to perform customized validation training of an ML model, prior to deploying the ML model in a specified ML application to be powered by the ML model. ML model validation customizer system 401 comprises a custom goal detection module 402, a quality pillar performance category importance determining module 404, an ML validation test generating module 406, and an ML validation test performing module 408. Functions and aspects of ML model validation customizer system 401 and of these specific modules thereof are apparent from the description below and the accompanying figures.

In various embodiments, ML model validation customizer system 401 may customize sets of test and validation modules to align with the specific custom performance requirements and goals of a particular ML application. ML model validation customizer system 401 may customize quality assurance (QA) validation flow for the specific custom needs and performance goals of an ML model and its specific application and use case. In various aspects, ML model validation customizer system 401 may automate extraction and scaling of custom use cases from existing data, configuration files, and other use case information, in various aspects. ML model validation customizer system 401 may automatically determine relative custom importance of each of various quality pillar performance categories, and may automatically customize testing and validation based on that determined importance of the quality pillar performance categories, while enabling users with flexible options to further configure the testing and validation. In various aspects, ML model validation customizer system 401 may also customize dynamic generation of training data based on the automatedly determined relative custom importance of the various quality pillar performance categories.

ML model validation customizer system 401 may enable balancing between various quality pillars, such as accuracy, runtime and memory consumption, security, etc. Such customized relative scaling of quality pillars based on their determined custom importance specific to a particular application may help in designing a custom validation flow to ensure that the ML model is ready for a particular use case. For example, a higher importance on runtime memory constraints may require a tradeoff on the number of test inputs for validation of accuracy and explainability, and so on. Additionally, ML model validation customizer system 401 may validate data, and may generate further supplemental data for identified dynamic tests based on the customized relative scaling of quality pillars and a determined custom importance specific to a particular application. Further, the ML model validation customizer system 401 may generate user-friendly reports.

In embodiments, ML model validation customizer system 401 may offer customized testing scenarios. Further, the model validation customizer system 401 may apply customized weights to those customized testing scenarios based on the determined custom importance of the quality pillars specific to the application. In particular, ML model validation customizer system 401 may offer user-selectable options for latency of an ML model and for storage requirements of an ML model. ML model validation customizer system 401 may offer template blocks for quality pillars relating to code, such as execution time, explainability, and model metrics. ML model validation customizer system 401 may perform polarity analysis of requirements documentation, such as configuration files, for example, to identify conflicting interests in quality pillar performance categories. The quality pillar performance categories may be the basis for corresponding quality pillar template blocks. ML model validation customizer system 401 may also perform dynamic creation of test and validation flow including corner and edge case tests. The ML model validation customizer system 401 may generate multi-variety test data for identified tests, and may present user-friendly reports via user interfaces to end users.

In various examples described herein, ML model validation customizer system 401 may save substantial amounts of manual effort, compute cost, and effort and cost of generating supplemental data relative to known methods. ML model validation customizer system 401 may ensure quality with automated, scalable, and exhaustive validation. With customizable validation, ML model validation customizer system 401 may cover more use cases than in known systems. ML model validation customizer system 401 may cover all quality pillars at customized weights. Thus, ML model validation customizer system 401 may enable novel and inventive capability to provide production-ready, user-friendly ML model applications.

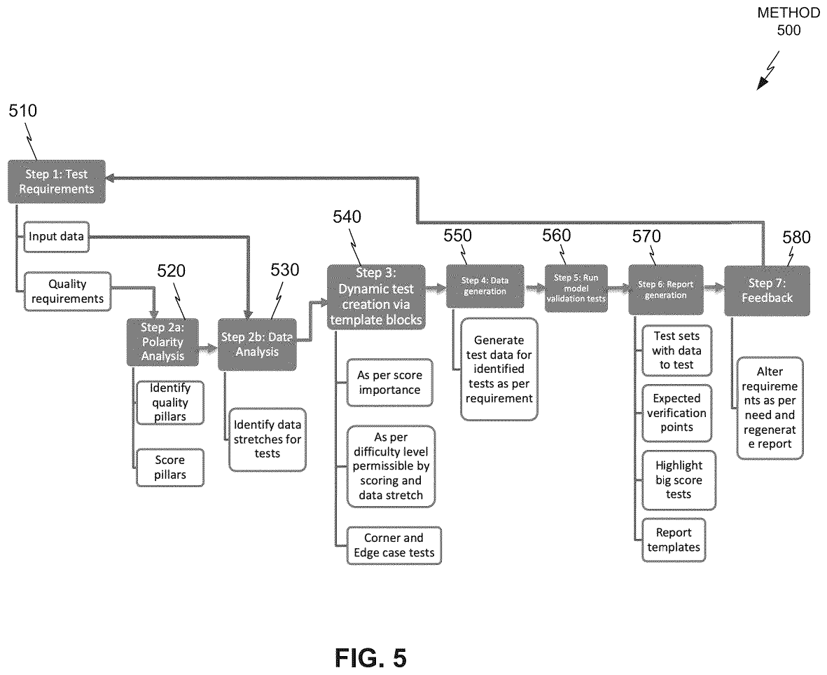

In various embodiments, ML model validation customizer system 401 comprises custom goal detection module 402, a quality pillar performance category importance determining module 404, an ML validation test generating module 406, and an ML validation test performing module 408, each of which may comprise one or more program modules such as program modules 42 described with respect to FIG. 1. The functions of each of modules 402, 404, 406, and 408 are further described with reference to FIG. 5 and throughout this disclosure. For example, custom goal detection module 402 may detect custom goals of a specified machine learning application. In various examples, quality pillar performance category importance determining module 404 may determine relative importance of a plurality of performance categories for the specified machine learning application, based on the custom goals of the specified machine learning application. In various examples, ML validation test generating module 406 may generate automated machine learning model tests for a machine learning model (e.g., which may be for powering the specified machine learning application), based on the determined relative importance of the plurality of performance categories for the specified machine learning application. In various examples, ML validation test performing module 408 may perform validation testing of the machine learning model based on the automated machine learning model tests, in cloud-deployed machine learning applications. In various embodiments, ML model validation customizer system 401 may include additional or fewer modules than those shown in FIG. 4. In various embodiments, separate modules may be integrated into a single module. Additionally, or alternatively, a single module of any of those depicted in FIG. 4 may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

FIG. 5 shows a flowchart of an exemplary method 500 in accordance with aspects of the present invention. Steps of the method may be carried out by ML model validation customizer system 401 in environment 400 of FIG. 4 and are described with reference to elements depicted in FIG. 4.

At step 510, ML model validation customizer system 401 may analyze test requirements. In particular, the ML model validation customizer system 410 may include analyzing the requirements and goals of an application to be powered by an ML model and how the requirements and goals of the application relate to test requirements. In various embodiments, step 510 may include analyzing input data and quality requirements. In various examples, step 510 may be performed by custom goal detection module 402 as in FIG. 4.

The requirements and goals of the application to be powered by the ML model may generally be referred to as custom goals of the specified ML application. These custom goals may include test requirements and quality requirements such as target test coverage areas related to business use cases, and thresholds for each preferred area. Test requirements may include sample data inputs, which may include data schema, and samples of anonymized data.

Test requirements may include data generation inputs. Data generation inputs may include data that was originally used to teach the model relationship between features, custom data generation rules, such as a custom data distribution with a sudden steep increase or decrease, and real world data distributions that are relevant to a business use case or model under test.

Test requirements may also include validation of type inputs. Accordingly, validation of type inputs may include determining whether data are valid or invalid data, out of range, valid or invalid data types, protected or unprotected types of data, or valid or invalid file formats. The validation of type inputs may also include determining whether data conform to boundary conditions, or show unexpected feature inputs or feature range disparity, for example.

At step 520, ML model validation customizer system 401 may perform polarity analysis on the test requirements. Accordingly, polarity analysis on the test requirements may include identifying quality pillar performance categories, and scoring and/or ranking the quality pillars. Performing the polarity analysis may be a form of determining relative importance of a plurality of performance categories for the specified machine learning application, based on the detected custom goals of the specified machine learning application. In various examples, step 520 may be performed by quality pillar performance category importance determining module 404 as in FIG. 4. Step 520 is further described below.

Further with regard to step 520, model validation customizer system 401 performing polarity analysis on the test requirements may include analyzing configuration files or other test plan information and extracting or determining key-value pairs of test types and their importance. In particular, for the key-value pairs, the keys may be quality pillar performance categories and the values may be the relative importance of the keys. Model validation customizer system 401 may perform polarity analysis with respect to the list of values of keys and score and/or rank them. Model validation customizer system 401 may assign a relative or normalized importance score to each key or quality pillar based on the scoring and/or ranking. Model validation customizer system 401 may use these scores of relative importance to identify difficulty levels at which to cut off tests for each of the quality pillar performance categories. Cutting off the tests may include cutting the tests short, or applying a completion to the tests, e.g., at the identified levels corresponding to the relative importance of each of the quality pillar performance categories, which may include to override other completion conditions to apply completion to the tests, for example.

At step 530, ML model validation customizer system 401 may perform data analysis of the input data. Accordingly, data analysis of the input data may include identifying data stretches, or ways to generate auxiliary or supplemental data for the validation tests.

In implementations of steps 520 and 530, model validation customizer system 401 may perform polarity analysis and data analysis. Model validation customizer system 401 may generate relative importance values of quality pillar performance categories for the specified machine learning (ML) application of an AI recommendation system for cloud assets based on the custom goals of the specified AI recommendation system for cloud assets. For example, the custom goals may include Explainability—90 Percent, Robustness—70 Percent, Performance—75 Percent, Security—60 Percent, Monitoring—70 Percent, and Accuracy—55 Percent. Model validation customizer system 401 may determine and identify data stretches and varieties, e.g., identifying virtual machine (VM) asset data with very high utilization and on-demand, VM with medium utilization and on reserved instance, etc.

At step 540, ML model validation customizer system 401 may perform dynamic generating of validation tests. Accordingly, the dynamic generation of validation tests may occur via validation test template blocks. The dynamic generation of validation tests may also include generating tests in accordance with score importance of the quality pillar performance categories. Further, generating tests may be based on quality pillar performance categories in accordance with difficulty levels permissible by scoring and data stretch. The dynamic generation of validation tests may further include determining priorities for generating tests to cover edge cases and corner cases. Determining priorities for generating tests to cover edge cases and corner cases may include generating auxiliary test data, relative to tests, to cover more typical or nominal cases. In various examples, step 540 may be performed by ML validation test generating module 406 as in FIG. 4.

Further as part of step 540 of performing dynamic generating of validation tests, model validation customizer system 401 may design template blocks. Model validation customizer system 401 may identify the ML model type from parameters or configuration files, and may generate test cases in order of difficulty. Model validation customizer system 401 may include template blocks for comparing gold values and model values for various categories of inputs. Model validation customizer system 401 may identify the data diversity the model/architecture type can stretch to. Model validation customizer system 401 may identify links between ML model output and business rules from the configuration files. Model validation customizer system 401 may, for example, include template blocks for changed feature range, type, and schema. Model validation customizer system 401 may introduce sensitive or protected data (e.g., PHI data) and test for any sensitive or protected information leaked from the output of the ML model. Model validation customizer system 401 may include blocks for business rules met alone and in combination. Model validation customizer system 401 may include corner and edge cases per business rules identified using data range and variety analysis. Model validation customizer system 401 may also make use of any existing algorithms as part of pursuing any of these functions.

In an implementation of step 540, model validation customizer system 401 may create tests with template blocks. Model validation customizer system 401 may create a template block for each for the identified quality pillars with tests cut off at the proposed percent with verification points. For example, model validation customizer system 401 may create an explainability test scenario recommending a savings plan subscription purchase in case of very high utilization. Model validation customizer system 401 may also create template blocks for corner and edge cases based on validation input with verification points, e.g., sudden increase in utilization of an idle resource (e.g., a resource that has remained idle for three months).

Still referring to step 540 of FIG. 5, model validation customizer system 401 may use the variety analysis of data availability and importance score of a pillar to identify the difficulty level for the pillar either computed or determined from the addition of polarity analysis of test requirement. Model validation customizer system 401 may generate test cases for each difficulty level until the cut off threshold, potentially including tests for each data variety identified under each quality pillar, integration tests for end-to-end flow, and corner and edge case tests based on data range and boundary conditions, features and data schema, and validation type inputs.

At step 550, ML model validation customizer system 401 may generate auxiliary test data. This generating of auxiliary test data may be in accordance with determined priorities for generating test data based on performance categories and in accordance with permissible difficulty levels. In particular, permissible difficulty levels may be based on scoring and data stretch. Generating auxiliary test data may further include generating relatively extra auxiliary test data for tests to cover edge cases and corner cases, to provide ML model performance in edge cases and corner cases. The ML model performance in edge cases and corner cases may be at a level based on the determined relative importance of the quality pillar performance categories.

In further regard to step 550 of FIG. 5, based on identified test cases, model validation customizer system 401 may evaluate and determine whether the available sample data is sufficient, relative to the custom goals of the specified ML application. Accordingly, the model validation customizer system 401 may determine further data that may be generated for the validation testing. Model validation customizer system 401 may generate data based on a variety of inputs, e.g., end user inputs in the form of samples of anonymized data, data schema, custom data generation rules, variety of targeted data distributions, and validation types. Model validation customizer system 401 may generate data targeted for both positive and negative variety of test cases, may use pattern matching to generate similar or varied distributions of patterns or trends, and may generate missing data from user-specified data schema or custom data generation rules. For example, model validation customizer system 401 may generate very large amounts of data to test model performance, generate statistical variations of data based on business use cases, generate random data in a controlled manner that challenges the model output, and generate random noise interjected in a controlled manner that challenges the model performance.

In an implementation of step 550, model validation customizer system 401 may generate auxiliary data, such as test data from samples of data schema, anonymized customer data, and missing data sets from the available samples using custom data generation rules, e.g., generating missing data sets with very low utilization levels. In an implementation of step 570, model validation customizer system 401 may generate reports, which may display execution of tests against the testing verification, highlight big score tests with pass rate, and graphs for distribution of success rates, for example.

Referring again to step 550 of FIG. 5, model validation customizer system 401 may generate reports highlighting high-level validation details, test sets, test and verification details, and test data, and making use of report templates. For example, model validation customizer system 401 may highlight high-level validation details with model report headers or business use cases and quick views of captured test requirements. For example, with regard to test sets, model validation customizer system 401 may highlight test groups aligned with quality pillars and may highlight major score tests.

At step 560, ML model validation customizer system 401 may run model validation tests. Running the model validation tests may involve using test data from a pre-existing data set for the ML model and auxiliary data generated by ML model validation customizer system 401. In particular, the model validation customizer system 401 may run the model validation tests in accordance with the determined priorities based on the performance categories. In various examples, step 560 may be performed by ML validation test performing module 408 as in FIG. 4.

At step 570, ML model validation customizer system 401 may generate one or more reports on the validation tests. The generated reports may include tests sets with data that were used for the testing. The generated reports may include expected verification points and highlight high score tests. Validation customizer system 401 may use report templates in generating the reports.

At step 580, in view of the validation testing and the generated validation testing reports, ML model validation customizer system 401 may enable a user interface with one or more user interface elements that enable user feedback and interaction. The user interface may be enabled to receive user feedback to modify or alter custom requirements, design goals of the ML model, or the specified application powered by the ML model. The user interface may be enabled to receive user feedback to re-run and re-perform a portion of steps in the method 500 or all of the steps in method 500. The portion of steps in the method 500 or all of the steps in method 500 may include the validation testing and the report generating based on the newly modified custom requirements or design goals of the ML model or the specified application to be powered by the ML model. In such a re-executing of the process of method 500, ML model validation customizer system 401 may generate and use a new determination of the relative importance of each of the quality pillar performance categories, based on newly modified custom requirements, design goals of the ML model, or the specified application powered by the ML model.

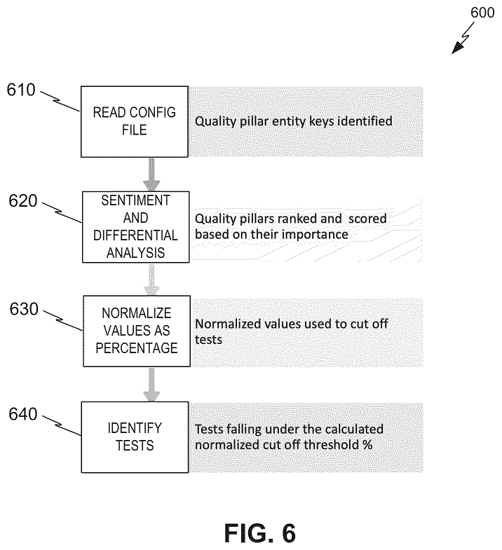

FIG. 6 depicts a flowchart for a method 600 for model validation customizer system 401 performing polarity analysis on the test requirements, in accordance with aspects of this disclosure. In step 610, model validation customizer system 401 may read a configuration file, and identify or determine quality pillar performance categories as keys. In step 620, model validation customizer system 401 may perform sentiment analysis on the importance of each of the quality pillar performance categories and generate a list of the scored importance values, and perform differential analysis of the importance values, scoring and/or ranking the quality pillar performance categories by relative importance to the custom goals of the specified ML application. In step 630, model validation customizer system 401 may normalize the importance values to be, e.g., percentages of 100, assign the normalized importance values as values of the quality pillar keys. In step 640, model validation customizer system 401 may use the normalized importance value percentages to cut off test sets for the different quality pillars.

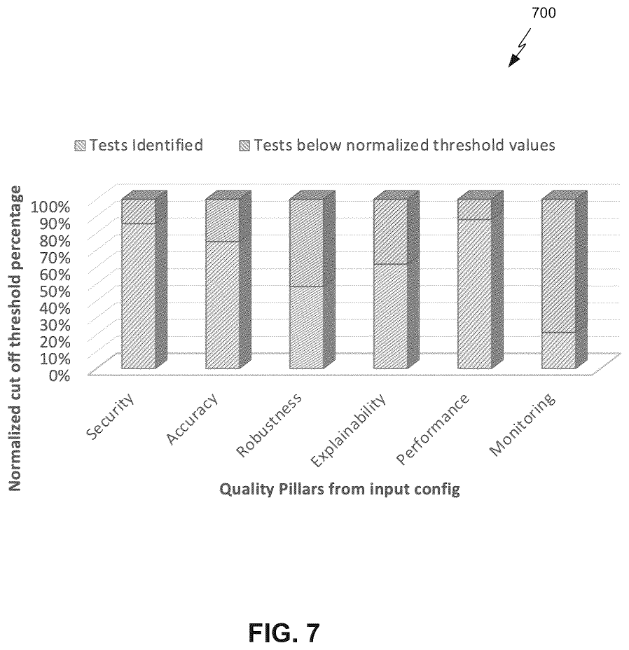

FIG. 7 depicts a bar chart 700 for a set of normalized relative value scores of a set of quality pillar performance categories based on the custom goals of a specified ML application, as determined in a polarity analysis by model validation customizer system 401, in accordance with aspects of this disclosure. Bar chart 700 also shows the percentage of identified validation tests that are within or outside of the normalized relative importance threshold values for each of the quality pillar performance categories. Thus, the model validation customizer system 401 includes or excludes, respectively, the identified tests for performing in the validation testing process for the specified ML application, to achieve a customized validation testing regime aligned with the custom goals of the specified ML application. As shown in Table 1 below, the quality pillar performance categories and their normalized relative importance scores are:

TABLE 1

| | |
|---|---|
| security | 80% |
| accuracy | 70% |
| robustness | 50% |
| explainability | 70% |
| processing performance | 90% |
| monitoring | 20% |

Referring again to FIG. 5, as part of step 530, model validation customizer system 401 may perform a variety analysis on data availability and how the variety analysis on data availability affects the different quality pillar performance categories. For example, data schema variety may affect model robustness and monitoring. Data range variety within the same schema may affect model accuracy and explainability. Data type changes within the same schema may affect model accuracy and explainability. Data protection or sensitivity level variety (e.g., protected health information (PHI)) within the same schema may affect model security. Data volume variety may affect model performance. Data source variety may affect model performance and robustness. Model validation customizer system 401 may score current data availability on each of these levels, and transfer the scores back to the importance of each test.

Model validation customizer system 401 may identify and generate automated ML model tests based on the quality pillar performance categories and the determined relative importance of the quality pillar performance categories for the specified ML application. For the quality pillar performance category of ML accuracy, model validation customizer system 401 may check for accuracy or F1 score (harmonic mean of precision and recall of a test) being above a selected threshold (e.g., 80% accuracy) on the ML application domain. Model validation customizer system 401 may test for feature selection, e.g., check for p value (or probability value for a probability of obtaining observed results based on assumptions), or variance inflation factor (VIF) values (measures of the amount of multicollinearity in regression analysis). In some examples, model validation customizer system 401 may refrain from evaluating non-impactful, multi-collinear, or interdependent features for assessing accuracy (e.g., where the time and compute of performing such evaluations, relative to devoting time and compute to other evaluations, would not be aligned with the relative importance of the quality pillars).

For the quality pillar performance category of robustness, model validation customizer system 401 may test using voluminous test data (e.g., 1 or 2 million records). Further, depending on the ML application, model validation customizer system 401 may perform tests using diversified data (e.g., data from multiple customers), multiple test runs to check that the results are as predicted, or test code flows based on input data. For the quality pillar performance category of explainability, model validation customizer system 401 may test whether the model final output has a predicted recommendation text. Thus, if the model final output has the predicted recommendation text, the predicted recommendation text may be displayed to users. Further, the model validation customizer system 401 may test rules used in predictions to align with business requirements.

For the quality pillar performance category of processing performance, model validation customizer system 401 may test for model performance using monitoring tools, and check whether the model expands the processing burden beyond a selected threshold or an average threshold for a defined data size. Model validation customizer system 401 may also test whether the model fails gracefully and whether the model expands the processing burden or falls into a processing performance trap in a situation of incorrect or unexpected data. Model validation customizer system 401 may also test whether the model fails gracefully in the situation of sparse data.

For the quality pillar performance category of security, model validation customizer system 401 may test whether the model keeps feedback on errors to a minimum (e.g., avoids returning detailed error codes or confidence values to end users) and may also test whether the model reduces sensitive outputs of training data or learning models. For the quality pillar performance category of monitoring, model validation customizer system 401 may test whether the ML model final output has the predicted recommendation text to display to users, may test rules used in predictions to align with business requirements, and may test memory usage. In various embodiments, model validation customizer system 401 may also evaluate and generate other quality pillar performance categories.

With regard to test and verification details, model validation customizer system 401 may, for each test, show test type, test details, and a list of verification points and expected proven results. For example, with regard to test data, model validation customizer system 401 may display data, both sample data and generated data, corresponding with each test. Model validation customizer system 401 may generate the report such that the data is viewable and downloadable. With regard to report templates, model validation customizer system 401 may provide user interface options that enable users to choose from available templates to view the report. In particular, the report templates may be customizable, and the report may format and display graphs for distribution of tests and success rates.

These aspects may be described in reference to a specific example in the domain of an AI recommendation system for cloud management. With reference to FIG. 5, in an implementation of step 510, model validation customizer system 401 may read business requirements to specify a high-end AI recommendation system for cloud assets based on the cost, asset and metrics data showing a range of recommendations for shutoff, schedule, buy savings plan/reserved instances, etc. Thus, the model validation customizer system 401 may have a good amount of explainability, customer data, including cost, asset, and metrics data, target coverage areas and their importance value, sample data schema, validation inputs, and data generation inputs (e.g., variations of customer data with different subscriptions, usage levels, and cost parameters) in comparison to known systems.

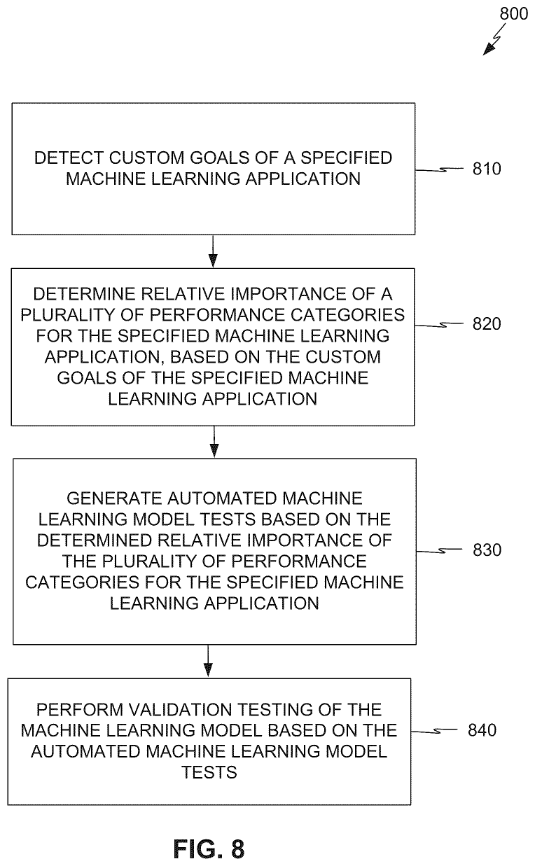

FIG. 8 depicts a flowchart for an illustrative method 800, in accordance with aspects of this disclosure. Method 800 may be performed by model validation customizer system 401, in various examples. In step 810, model validation customizer system 401 may detect custom goals of a specified machine learning application. Step 810 may correspond with step 510 and may be performed by custom goal detection module 402 in FIG. 4. In step 820, model validation customizer system 401 may determine relative importance of a plurality of performance categories for the specified machine learning application, based on the custom goals of the specified machine learning application. Step 820 may correspond with step 520 and may be performed by quality pillar performance category importance determining module 404 in FIG. 4. In step 830, model validation customizer system 401 may generate automated machine learning model tests for a machine learning model (e.g., for powering the specified machine learning application), based on the determined relative importance of the plurality of performance categories for the specified machine learning application. Step 830 may correspond with step 540 and may be performed by ML validation test generating module 406 in FIG. 4. In step 840, model validation customizer system 401 may perform validation testing of the machine learning model based on the automated machine learning model tests. Step 840 may correspond with step 560 and may be performed by ML validation test performing module 408 in FIG. 4.

In various embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
detecting, by one or more processing devices, custom goals of a specified machine learning application;
determining, by the one or more processing devices, relative importance of a plurality of performance categories for the specified machine learning application, based on the custom goals of the specified machine learning application;
generating, by the one or more processing devices, automated machine learning model tests based on the determined relative importance of the plurality of performance categories for the specified machine learning application; and
performing, by the one or more processing devices, validation testing of a machine learning model based on the automated machine learning model tests.

2. The method of claim 1, further comprising:
generating supplemental test data for the automated machine learning model tests,
wherein the performing the validation testing of the machine learning model is further based on the generated supplemental test data, and the automated machine learning model tests are for the machine learning model for powering the specified machine learning application.

3. The method of claim 1, wherein the determining the relative importance of the plurality of performance categories based on the custom goals of the specified machine learning application comprises determining the relative importance for the specified machine learning application, based on the custom goals of the specified machine learning application, of at least two of: accuracy, runtime, memory consumption, security, robustness, explainability, and monitoring capability, of the specified machine learning application.

4. The method of claim 1, wherein the generating the automated machine learning model tests for the machine learning model based on the determined relative importance of the plurality of performance categories for the specified machine learning application comprises generating a template block for each of the performance categories.

5. The method of claim 1, further comprising cutting off tests for each of one or more of the performance categories, respectively based on the determined relative importance for the one or more of the performance categories.

6. The method of claim 1, further comprising performing polarity analysis of the custom goals to identify conflicting interests in the performance categories.

7. The method of claim 1, wherein the generating the automated machine learning model tests further comprises dynamically creating test and validation flow, including corner and edge case tests.

8. The method of claim 1, further comprising generating reports detailing the validation testing of the machine learning model based on the automated machine learning model tests.

9. The method of claim 1, further comprising customizing sets of test and validation modules to align with specific custom performance requirements and the custom goals of the specified machine learning (ML) application powered by the machine learning model, and customizing quality assurance (QA) validation flow for specific custom needs and performance goals of the ML model.

10. The method of claim 1, wherein the method is provided as a service in a cloud environment.

11. A computer program product comprising one or more computer readable storage media having program instructions collectively stored on the one or more computer readable storage media, the program instructions executable to:
detect custom goals of a specified machine learning application;
determine relative importance of a plurality of performance categories for the specified machine learning application, based on the custom goals of the specified machine learning application;
generate automated machine learning model tests based on the determined relative importance of the plurality of performance categories for the specified machine learning application; and
perform validation testing of a machine learning model based on the automated machine learning model tests.

12. The computer program product of claim 11, wherein the program instructions are further executable to:
generate supplemental test data for the automated machine learning model tests,
wherein the performing the validation testing of the machine learning model is further based on the generated supplemental test data, and the automated machine learning model tests are for the machine learning model for powering the specified machine learning application.

13. The computer program product of claim 11, wherein the program instructions for determining the relative importance of the plurality of performance categories based on the custom goals of the specified machine learning application are further executable to determine the relative importance for the specified machine learning application, based on the custom goals of the specified machine learning application, of at least two of: accuracy, runtime, memory consumption, security, robustness, explainability, and monitoring capability, of the specified machine learning application.

14. The computer program product of claim 11, wherein the program instructions for generating the automated machine learning model tests for the machine learning model based on the determined relative importance of the plurality of performance categories for the specified machine learning application are further executable to generate a template block for each of the performance categories.

15. The computer program product of claim 11, wherein the program instructions are further executable to cut off tests for each of one or more of the performance categories, respectively based on the determined relative importance for the one or more of the performance categories.

16. A system comprising:
a processor, a computer readable memory, one or more computer readable storage media, and program instructions collectively stored on the one or more computer readable storage media, the program instructions executable to:
detect custom goals of a specified machine learning application;
determine relative importance of a plurality of performance categories for the specified machine learning application, based on the custom goals of the specified machine learning application;
generate automated machine learning model tests, based on the determined relative importance of the plurality of performance categories for the specified machine learning application; and
perform validation testing of a machine learning model based on the automated machine learning model tests.

17. The system of claim 16, wherein the program instructions are further executable to:
generate supplemental test data for the automated machine learning model tests,
wherein the performing the validation testing of the machine learning model is further based on the generated supplemental test data, and the automated machine learning model tests are for the machine learning model for powering the specified machine learning application.

18. The system of claim 16, wherein the program instructions for determining the relative importance of the plurality of performance categories based on the custom goals of the specified machine learning application are further executable to determine the relative importance for the specified machine learning application, based on the custom goals of the specified machine learning application, of at least two of: accuracy, runtime, memory consumption, security, robustness, explainability, and monitoring capability, of the specified machine learning application.

19. The system of claim 16, wherein the program instructions for generating the automated machine learning model tests for the machine learning model based on the determined relative importance of the plurality of performance categories for the specified machine learning application are further executable to generate a template block for each of the performance categories.

20. The system of claim 16, wherein the program instructions are further executable to cut off tests for each of one or more of the performance categories, respectively based on the determined relative importance for the one or more of the performance categories.
